(19) United States
(12) Patent Application Publication
(10) Pub. No.: US 2003/0041684 A1
(43) Pub. Date: Mar. 6, 2003

(54) Cable transmission shift converter

(76) Inventor: Robert L. Jones, Jr., Montgomery, AL (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/865,157

(22) Filed: May 24, 2001

Related U.S. Application Data
(60) Provisional application No. 60/223,489, filed on Aug. 7, 2000.
(60) Provisional application No. 60/258,922, filed on Dec. 29, 2000.

(51) Int. Cl. F16C 1/10

(52) U.S. Cl. 74/473.15

(57) ABSTRACT

A cable transmission shift converter for use when replacing the transmission in a right hand drive vehicle with a transmission designed for a left hand drive vehicle. The cable shift converter includes two brackets and a control cable and transmits movement of the original shift rod to the transmission shift lever on the left side of the transmission. A mounting bracket is mounted directly to the right side of the frame of the vehicle, while a second angled bracket is mounted to the left side of the replacement transmission. When the driver shifts the vehicle into gear, the shift rod actuates a bell crank causing a connector rod to transmit movement through the control cable to a second connector rod, which activates a crank arm that translates the movement to the transmission shift lever.

This application claims the benefit of U.S. Provisional Application No. 60/223,489, filed Aug. 7, 2000, and U.S. Provisional Application No. 60/258,922, filed Dec. 29, 2000, which documents are incorporated herein by reference.

### FIELD OF THE INVENTION

This invention relates to a cable transmission shift converter for use in the installation of a vehicle transmission, particularly for use when replacing the transmission in a right hand drive vehicle with a transmission designed for a left hand drive vehicle.

### BACKGROUND OF THE INVENTION

The United States Postal Service utilizes Grunman LLV-A vehicles, referred to as “LLV Delivery Trucks,” for mail delivery. The original equipment transmissions in LLV Delivery Trucks are General Motors 180 Chevette transmissions. The LLV Delivery Trucks are right hand drive vehicles, and accordingly, the GM 180 Chevette transmission shifts on the right side of the unit. Because of a history of numerous transmission failures associated with the use of GM 180 Chevette transmissions in LLV Delivery Trucks, the U.S. Postal Service elects to substitute in these vehicles a stronger transmission, the General Motors 700R4 transmission.

The GM 700R4 transmission is used as original equipment in Chevy S-10 pickup trucks. The GM 700R4 transmission is made for left hand drive vehicles and shifts on the left side of the unit. Thus, in order to install the GM 700R4 transmission in a LLV Delivery Truck, it is necessary to connect the LLV shift rod to the 700R4 transmission in a manner that permits successful control of the transmission. Such a connection has previously been accomplished by a right-to-left changeover linkage connecting the shift rod on the right side of the vehicle to the transmission shift lever on the left side of the transmission.

### SUMMARY OF THE INVENTION

This invention is an apparatus that permits the use in a vehicle of a transmission that shifts on a different side from that of the original equipment transmission. An embodiment of the invention permits reliable use of the GM 700R4 transmission in LLV Delivery Trucks and other vehicles that originally used right hand drive transmissions, where the transmission shift lever is on the right side of the transmission. The invention provides a cable transmission shift converter that may be installed easily and quickly. The cable shift converter transmits movement of the original shift rod, on the right side of the vehicle, to the transmission shift lever located on the left side of the 700R4 transmission.

The cable shift converter includes two brackets and a control cable. A mounting bracket is mounted directly to the right side of the frame of the vehicle, while a second angled bracket is mounted to the left side of the 700R4 replacement transmission. The control cable is attached to the mounting bracket at a first end of the control cable and the angled bracket at a second end of the control cable. A connector rod is coupled to each end of the control cable. A bell crank is attached to the mounting bracket via a rotatable sleeve and connects to the shift rod of the vehicle at a first end of the bell crank. At a second end of the bell crank, the bell crank is coupled to a connector rod, using a clevis and a pin, at the first end of the control cable. The second end of the control cable is attached to the angled bracket and is coupled to a second connector rod. The second connector rod is coupled to a crank arm using a clevis and a pin, and the crank arm is coupled to the transmission shift lever on the left side of the transmission. When the driver shifts to “reverse” or “drive,” the shift rod actuates the bell crank causing the first connector rod to move. This translates the movement to the control cable, which activates the second connector rod. The movement of second connector rod causes the crank arm to actuate, thereby translating the movement to the transmission shift lever.

The control cable may be made from polytetrafluoroethylene (PTFE)-coated (Teflon® brand) marine cable, thereby preventing the control cable from rusting or freezing. Also, the cable shift converter of the present invention may be easily installed without the removal of many other vehicle parts and will not interfere with or require modification of any vehicle parts when installed. Because it is mounted to the frame of the vehicle and the transmission and utilizes flexible cable, the cable shift converter is not required to be removed when performing vehicle maintenance. In a preferred embodiment, the mounting bracket attaches directly to the vehicle frame, which eliminates roll away caused by a broken transmission mount. In an alternate embodiment, the mounting bracket may be mounted on the right side of the transmission rather than the frame of the vehicle.

### BRIEF DESCRIPTION OF THE DRAWINGS

FIG. 1 is a perspective view of an embodiment of the cable shift converter of the present invention, with a transmission shown to illustrate a typical relationship of the cable shift converter to the transmission.

FIG. 2 is a detailed view of an embodiment of the shift rod adapter portion of the embodiment of the present invention shown in FIG. 1.

FIG. 3 is a detailed view of an embodiment of the transmission shift lever adapter portion of the embodiment of the present invention shown in FIG. 1.

### DETAILED DESCRIPTION OF THE INVENTION

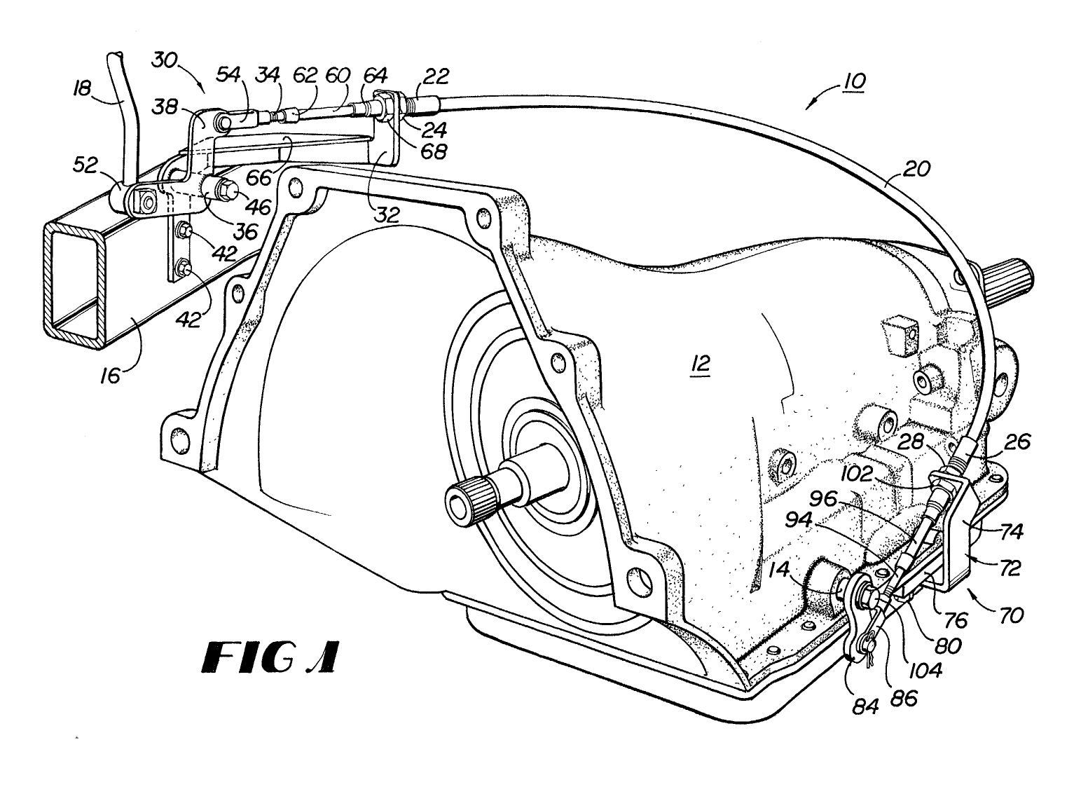

A cable shift converter 10 of this invention is depicted in FIG. 1, which shows the relationship of cable shift converter 10 to a transmission 12. Cable shift converter 10 consists of a control cable 20, a shift rod adapter 30, and a transmission shift lever adapter 70. Cable shift converter 10 allows a user to replace a right-hand shift transmission with a left-hand shift transmission in a vehicle originally designed to use the right-hand shift transmission.

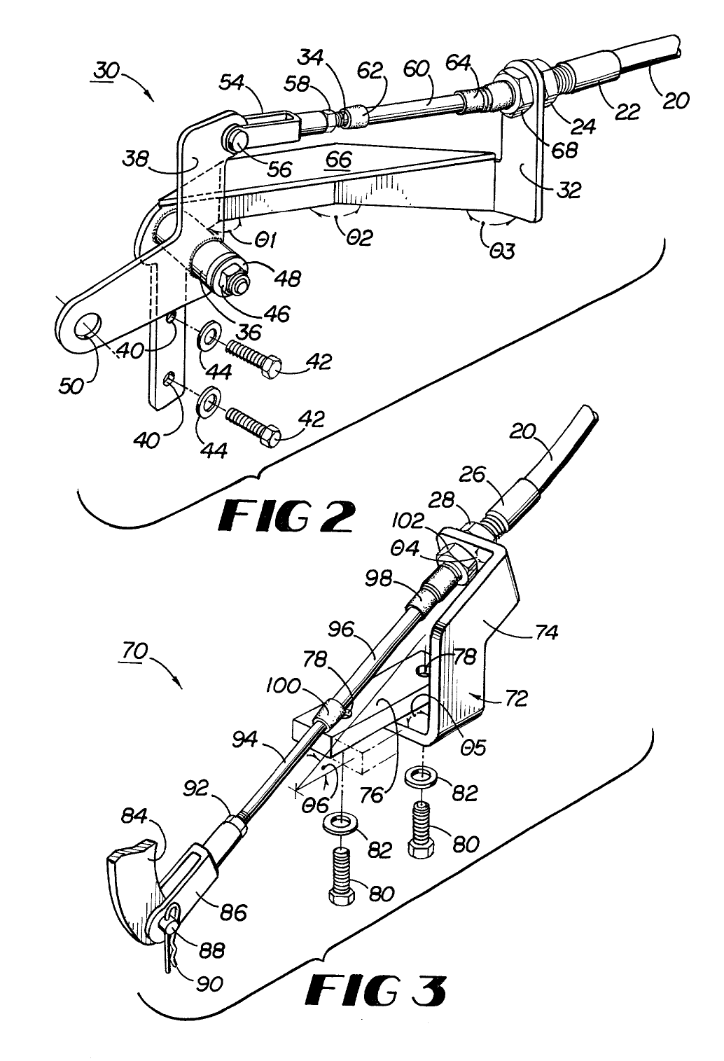

Referring to FIGS. 1 and 2, shift rod adapter 30 is formed from a mounting bracket 32, a connector rod 34, a rotatable sleeve 36, and a bell crank 38. Mounting bracket 32 is mounted directly to a frame 16 of a vehicle. In another embodiment, mounting bracket 32 may be mounted on the right side of the transmission rather than the frame of the vehicle. Mounting bracket 32 contains two integrally-formed holes 40 for attaching mounting bracket 32 to frame 16. In order to secure mounting bracket 32 to frame 16, bolts 42 and washers 44 are used. Frame 16 has preexisting holes (not shown) that may be aligned with holes 40 so that bolts 42 extend therethrough in order to attach mounting bracket 32 to frame 16.

Rotatable sleeve 36 is mounted on an axle (not shown) that extends from mounting bracket 32 and rides on bearings (not shown) between the axle and rotatable sleeve 36 to facilitate smooth movement of rotatable sleeve 36 with minimal wear. Rotatable sleeve 36 is held in place on the axle using a nut 46 and a washer 48. Alternatively, rotatable sleeve 36 may be coupled to the axle using a bushing. Bell crank 38 is mounted to rotatable sleeve 36 by weldments. Bell crank 38 may also be integrally formed with rotatable sleeve 36.

Bell crank 38 is coupled to connector rod 34 at one end and to a shift rod 18 of the vehicle at another end, as shown in FIG. 1. To connect shift rod 18 to cable shift converter 10, shift rod 18 is connected to bell crank 38 using an integrally-formed hole 50 and a connector 52. Connector 52 has a hole that shift rod 18 slides into and a set screw that tightens to hold shift rod 18 in place within connector 52. Bell crank 38 is connected to connector rod 34 using a clevis 54 and a pin 56. Pin 56 is extended through clevis 54 and an integrally-formed hole (not shown) in bell crank 38. Clevis 54 is threaded onto connector rod 34 and locked in place with a nut 58.

Connector rod 34 runs from bell crank 38 to control cable 20. Connector rod 34 is connected to control cable 20 inside a sheath which envelops control cable 20. A guide tube 60 acts as a casing to cover and protect connector rod 34 as it extends and retracts upon movement of bell crank 38. Dust boots 62 and 64 at each end of guide tube 60 facilitate smooth movement of connector rod 34 and protect the device from dust and debris where connector rod 34 enters and exits guide tube 60. Control cable 20, connector rod 34, and guide tube 60 may be assembled or connected piece by piece. Alternatively, a single cable assembly unit including control cable 20, its outer sheath, connector rods 34 and 94, guide tubes 60 and 96, dust boots 62, 64, 98, and 100, nipples 22 and 26, and locking nuts 24, 28, 68, and 102 may be purchased at, for example, Birmingham Powertrain located at 201 39^{th} Street North, Birmingham, Ala. 35222.

A nipple 22 at one flexible end of control cable 20 extends through and is attached to mounting bracket 32 by nuts 24 and 68 that trap mounting bracket 32. A reinforcement plate 66 welded to mounting bracket 32 strengthens and stabilizes mounting bracket 32. Mounting bracket 32 is formed from a metal plate that is bent into shape and contains multiple bends that facilitate mounting and operation of the control shift converter. The angles of each of three bends are marked in FIG. 2 as θ1, θ2, and θ3. In a preferred embodiment, θ1 and θ2 are approximately 145 degrees and θ3 is approximately 135 degrees.

Transmission shift lever adapter 70, shown in FIGS. 1 and 3, is formed from an angled bracket 72, a crank arm 84, and a connector rod 94. Angled bracket 72 consists of a bent plate 74 and a flat metal plate 76 welded or otherwise attached to bent plate 74. Metal plate 76 is penetrated by two holes 78 for receiving bolts 80 to secure angled bracket 72 to transmission 12. Bolts 80 extend through holes 78 that are aligned with holes in the bottom of the transmission oil pan. Washers 82 are used between bolts 80 and angled bracket 72.

Crank arm 84 is coupled to connector rod 94 at one end and to a transmission shift lever 14 at another end, as shown in FIG. 1, to convert linear movement of control cable 20 into rotation of transmission shift lever 14. Transmission shift lever 14 is threaded and slides into a slot in crank arm 84, and a nut 104 is used to secure this connection. Transmission shift lever 14 is a part of transmission 12. Crank arm 84 is shaped so that it may travel around and avoid contact with the oil pan of the transmission, which protrudes out from the transmission. Crank arm 84 is connected to connector rod 94 using a clevis 86, a pin 88, and a cotter pin 90, as shown in FIG. 3. Clevis 86 is threaded onto connector rod 94 and locked in place with a nut 92.

Connector rod 94 extends from crank arm 84 to control cable 20. Connector rod 94 is connected to control cable 20 inside a sheath which envelops control cable 20. A guide tube 96 acts as a casing to cover and protect connector rod 94 as it extends and retracts upon movement of control cable 20. Dust boots 98 and 100 are at each end of guide tube 96 to facilitate smooth movement of connector rod 94 and to protect the device from dust and debris at the contact points between guide tube 96 and connector rod 94.

A nipple 26 at one flexible end of control cable 20 extends through and is attached to angled bracket 72 by nuts 28 and 102 that trap angled bracket 72. The angles of two bends in angled bracket 72 are marked in FIG. 3 as θ4 and θ5. In a preferred embodiment, θ4 and θ5 are approximately 90 degrees. Additionally, the angle between the plane of flat metal plate 76 and the plane of the portion of angled bracket 72 around which nuts 28 and 102 are located is approximately 75 degrees in a preferred embodiment. This angle is marked as θ6 in FIG. 3.

Control cable 20 is attached between shift rod adapter 30 and transmission shift lever adapter 70. At one end, control cable 20 is attached to mounting bracket 32 and coupled to connector rod 34, and connector rod 34 is coupled to bell crank 38, which is coupled to shift rod 18. At its other end, control cable 20 is attached to angled bracket 72 and coupled to connector rod 94, and connector rod 94 is coupled to crank arm 84, which is coupled to transmission shift lever 14.

When the driver shifts to “reverse” or “drive,” shift rod 18 actuates bell crank 38 causing connector rod 34 to move. Connector rod 34 translates the movement to control cable 20, which activates connector rod 94. The movement of connector rod 94 causes crank arm 84 to move thereby translating the movement to transmission shift lever 14. When the driver moves shift rod 18 from park to a gear, cable shift converter 10 causes transmission shift lever 14 to move, making the transmission shift to the proper gear selected. Since cable shift converter 10 connects directly to the original shift rod, shift rod 18, the shift points are exact and no adjustments are needed.

For a preferred embodiment, each arm of bell crank 38 extending out from rotatable sleeve 36 is about 3.5 inches to about 4 inches in length. Crank arm 84 is approximately 1 inch wide and about 3 inches in length. For alternate embodiments, the above dimensions of bell crank 38 and crank arm 84 would need to be adjusted to produce the desired result, which is that a particular quantity of movement of shift rod 18 produces the corresponding movement in transmission shift lever 14. The dimensions of bell crank 38 and crank arm 84 would differ depending on the model of transmission and the model of vehicle into which the transmission is placed. Furthermore, for alternate embodiments, angles 01 through 06 may also vary, depending on the model of transmission and vehicle, in order to produce the desired result.

This cable shift converter has several benefits over other systems currently in use. For example, in a preferred embodiment, the mounting bracket attaches directly to the vehicle frame which eliminates roll away (where the transmission shifts gears or pops out of a gear) caused by a broken transmission mount, which allows the transmission to rotate on its longitudinal axis. Additionally, the control cable may be made from polytetrafluoroethylene (PTFE) (Teflon® brand) coated marine cable thereby preventing it from rusting or freezing.

This cable shift converter may be easily installed without the removal of many other vehicle parts and will not interfere with or require modification of any vehicle parts when installed. Finally, because it is mounted to the frame of the vehicle and the transmission and utilizes flexible cable, cable shift converter 10 is not required to be removed when performing vehicle maintenance.

The cable transmission shift converter of this invention overcomes many disadvantages associated with other types of transmission shift converters or adapters currently in use. As will be understood by one skilled in the art, the details of the structure depicted in the accompanying drawing and described above can be varied without departing from the scope or spirit of this invention or the following claims. For instance, modifications can be made in the exact shapes and dimensions of the above-described components, and other components can be substituted while continuing to provide a transmission shift converter that is sturdy, accurate, durable, and highly functional.

1. A transmission shift converter for coupling a vehicle shift control positioned on one side of a transmission to a transmission shift control protruding from the other side of the transmission, the converter comprising:
(a) a cable, wherein a first end of the cable is coupled to a first linkage and a second end of the cable is coupled to a second linkage;
(b) a first bracket and a second bracket, wherein the first bracket is mounted to a frame of the vehicle and the second bracket is mounted to the transmission and the cable is attached to the first bracket and the second bracket; and
(c) a first rotational component and a second rotational component, wherein the first rotational component is coupled to the first linkage and the second rotational component is coupled to the second linkage, and further where the first rotational component is coupled to the vehicle shift control and the second rotational component is coupled to the transmission shift control.

2. The transmission shift converter of claim 1, wherein the first rotational component further comprises a bell crank.

3. The transmission shift converter of claim 2, wherein the bell crank is mounted on a rotatable sleeve mounted on an axle extending from the first bracket.

4. The transmission shift converter of claim 1, wherein each linkage comprises a rod threaded on one end where a clevis is threaded onto said end of the rod.

5. The transmission shift converter of claim 1, wherein the cable is flexible.

6. The transmission shift converter of claim 1, wherein the cable is coated with polytetrafluoroethylene (PTFE).

7. A transmission shift converter for coupling a vehicle shift control positioned on one side of a transmission to a transmission shift control protruding from the other side of the transmission, the converter comprising:
(a) a first bracket;
(b) a second bracket mounted to the transmission;
(c) a first crank arm attached to the first bracket, wherein, at a first end of the first crank arm, the first crank arm is coupled to the vehicle shift control and, at a second end of the first crank arm, the first crank arm is coupled to a first rod;
(d) a cable connected to the first bracket and the second bracket, wherein at a first end of the cable, the cable is coupled to the first rod and, at a second end of the cable, the cable is coupled to a second rod; and
(e) a second crank arm, wherein, at a first end of the second crank arm, the second crank arm is coupled to the transmission shift control and, at a second end of the second crank arm, the second crank arm is coupled to the second rod.

8. The transmission shift converter of claim 7, further comprising a rotatable sleeve mounted an axle extending from the first bracket.

9. The transmission shift converter of claim 8, wherein the first crank arm is mounted to the rotatable sleeve.

10. The transmission shift converter of claim 7, wherein the first bracket is mounted to the transmission.

11. The transmission shift converter of claim 7, wherein the first bracket is mounted to a frame of the vehicle.

12. The transmission shift converter of claim 7, wherein each rod is threaded on one end where a clevis is threaded onto said end of the rod.

13. The transmission shift converter of claim 7, wherein the cable is flexible.

14. The transmission shift converter of claim 7, wherein the cable is coated with polytetrafluoroethylene (PTFE).

15. A method for controlling an automatic transmission having a vehicle shift control on one side of the transmission and a transmission shift control protruding from the other side of the transmission comprising:
(a) using the vehicle shift control to impart rotational motion to a first rotational component on the vehicle shift control side of the transmission;
(b) using the first rotational component to impart substantially linear motion to a first linkage;
(c) using the first linkage to impart substantially linear motion to a second linkage via the use of a cable;
(d) using the second linkage to transmit substantially linear motion to a second rotational component; and
(e) using the second rotational component to impart rotational motion to the transmission shift control.

16. The combination of a transmission and a transmission shift control converter for coupling a vehicle shift control positioned on a first side of the transmission to a transmission shift control protruding from a second side of the transmission, the combination comprising:
(a) the transmission;
(b) a first bracket;
(c) a second bracket mounted to the transmission;
(d) a first crank arm attached to the first bracket, wherein, at a first end of the first crank arm, the first crank arm is coupled to the vehicle shift control and, at a second end of the first crank arm, the first crank arm is coupled to a first rod;
(e) a cable connected to the first bracket and the second bracket, wherein at a first end of the cable, the cable is coupled to the first rod and, at a second end of the cable, the cable is coupled to a second rod; and
(f) a second crank arm, wherein, at a first end of the second crank arm, the second crank arm is coupled to the transmission shift control and, at a second end of the second crank arm, the second crank arm is coupled to the second rod.

17. The combination of claim 16, wherein the first bracket is mounted to the transmission.

18. The combination of claim 16, wherein the first bracket is mounted to a frame of the vehicle.

19. A transmission shift converter for coupling a vehicle shift control positioned on one side of a transmission to a transmission shift control protruding from the other side of the transmission, the converter comprising:
(a) a first bracket mounted to a frame of the vehicle, the first bracket being shaped such that the first bracket contains at least three bends as the first bracket extends from the frame of the vehicle, wherein a first angle of a first bend is approximately 145 degrees, a second angle of a second bend is approximately 145 degrees, and a third angle of a third bend is approximately 135 degrees;
(b) a second bracket mounted to the transmission comprising a bent plate and a flat metal plate attached to the bent plate, forming a fourth angle of approximately 90 degrees, wherein the bent plate extends vertically from the flat metal plate and has a generally L-shaped bend, forming a fifth angle of approximately 90 degrees, at which the bent plate is connected to a cable, and wherein a plane in which the generally L-shaped bend lies forms a sixth angle of approximately 75 degrees in relation to a plane in which the flat metal plate lies;
(c) a first crank arm attached to the first bracket, wherein, at a first end of the first crank arm, the first crank arm is coupled to the vehicle shift control and, at a second end of the first crank arm, the first crank arm is coupled to a first rod;
(d) the cable connected to the first bracket and the second bracket, wherein at a first end of the cable, the cable is coupled to the first rod and, at a second end of the cable, the cable is coupled to a second rod; and
(e) a second crank arm, wherein, at a first end of the second crank arm, the second crank arm is coupled to the transmission shift control and, at a second end of the second crank arm, the second crank arm is coupled to the second rod.
